(19) United States
(12) Patent Application Publication
(10) Pub. No.: US 2006/0250816 A1
(43) Pub. Date: Nov. 9, 2006

(54) Fiber illumination system for back lighting

(76) Inventors: Ju Gao, Champaign, IL (US); James L. Schoolenberg, Urbana, IL (US)

Correspondence Address: D. Joseph English, Suite 700, 1667 K STREET, WASHINGTON, DC, 20006, US

(21) Appl. No.: 11/397,558

(22) Filed: Apr. 5, 2006

Related U.S. Application Data
(60) Provisional application No. 60/668,069, filed on Apr. 5, 2005.

(51) Int. Cl. B64D 47/06; F21V 7/04

(52) U.S. Cl. 362/559; 385/147; 362/611; 362/615; 362/330

(57) ABSTRACT

An apparatus and method for providing backlighting for panel displays utilizing fiber optics.

### CLAIM OF PRIORITY

This application claims the filing date priority of U.S. Provisional Patent Application No. 60/668,069 filed Apr. 5, 2005, the contents of which is incorporated herein by reference.

### RELATED APPLICATIONS

This application is related to co-pending U.S. patent application Ser. No. 10/949,196 filed Sep. 27, 2004 entitled, “Integrated Light Distribution System Using Optical Waveguide With No Reflective Coupler,” which claims the benefit of U.S. Provisional Patent Application Ser. No. 60/505,429, the content of each are incorporated herein by reference.

### FIELD OF THE INVENTION

The present invention relates to systems for providing back lighting for panel displays such as liquid crystal displays.

### BACKGROUND OF THE INVENTION

Backlighting has been used in many applications, including televisions, radiology, commercial signs, computer systems, multi-media devices and other electronic devices, where the display unit itself does not emit light but rather modulates light output from a backlighting source. One example of such an application is the liquid crystal display (LCD). An LCD requires a source of light for operation because the LCD does not generate light, but modulates the light output intensity from a backlighting source by changing the polarization properties of the light that passes through, allowing transmission of light in one state and blocking transmission of light in a second state. Information is thus displayed as a result of the light intensity modulation for each pixel in the LCD panel. Systems utilizing backlighted LCD panels have become a popular panel display application due to the improved contrast ratios and brightness possible in such displays.

With the rapid advances in semiconductor technologies and the growth of demand for personal computers, cell phones, PDAs and the like, LCDs have become one of the preferred systems for the display panel in such devices. Although cathode ray tubes (CRT) are economical and have advantages in many aspects, possible production of hazardous radiation, the bulk of the display, and the relatively high power consumption are major factors that diminish the desirability of CRT's for displays such as personal computers. With better resolution, space utilization and power consumption, LCD panels have become a popular type of display. The technical demand on systems for backlighting LCD panels is to match the light weight, low heat and flat panel structures that are required by LCD panels.

Presently, backlighting sources for LCDs are primarily provided by one type of mercury discharge lamp. Similar to linear fluorescent and compact fluorescent lamps, these backlighting lamps are low pressure mercury discharge amps where the primary radiation is in the mercury ultraviolet (UV) spectrum. Phosphors may be coated on the lamp envelope to convert the UV radiation into a desired (white) color. These lamps may be thin and operate at relatively cold temperatures. An example of such lamps are cold cathode fluorescent lamps (CCFL). Because of the respective geometry, low heat, lumens efficacy and maturity in production, the CCFL has become the standard backlighting source for LCD technology.

For personal computer applications, a typical screen size may be between 14 inches and 17 inches measured along the diagonal. In such a range, a small number of CCFLs are sufficient for the required lumens. For a uniform light output from the respective display, light waveguides and diffusers may be utilized. Examples of such inventions are described by U.S. Pat. No. 7,018,086 to Mai, U.S. Pat. No. 6,992,733 to Klein, and U.S. Pat. No. 5,050,946 to Hathaway, et al.

In principle, LCD technology is not limited to the aforementioned 14 and 17 inch personal computer screen sizes. Generally, the dimensional limits placed on LCD displays have been largely due to processing and cost issues with regard to fabrication of defect free LCD panels. This problem has been solved recently and large screen LCD displays are made that rival the other type of flat screen technologies such as plasma display panels. However, large screen LCD panels require larger and brighter backlighting sources. The current solution is to increase the number of CCFLs utilized in the backlighting; however, such a solution presents several problems. For example, the increased number of CCFLs increases the demand for the respective ballasts and the difficulty of handling thereof, thus increasing the corresponding product cost. Another disadvantage is that CCFLs cannot possess an extended longitudinal dimension, thus several CCFLs must be utilized in a pattern to provide adequate backlighting for the entire dimension of the display panel. This may result in dark areas due to gaps between the CCFLs. Finally, the mercury inside the CCFLs continues to be an environmental concern.

Alternative backlighting for LCD technology and particularly large screen LCD panels is desirable. One such alternative is utilizing light emitting diodes (LED) for backlighting. However, several problems have been encountered with LEDs for backlighting. For example, individual LEDs do not provide sufficient lumens for backlighting requirements, thus large LED arrays must be used. Furthermore, such large LED arrays comparatively cost more and generate a significant amount of heat. Thus, there remains a need for an alternative backlighting system for LCD panel display systems.

It is therefore an object of the present disclosure to provide a novel backlighting device and method for panel displays which obviates the deficiencies of the prior art devices.

It is a further object of the present invention to provide a novel backlighting device and method for panel displays utilizing fiber optics.

It is a yet another object of the present invention to provide a novel backlighting device and method for panel displays comprising a light source and a pair of spaced apart substantially parallel panels, one of the panels having a light reflective surface facing the other panel, the other panel being light transmissive and forming a light exit face of the device. The device further comprises an optical fiber positioned between the panels and forming the lateral periphery of an illumination region, the fiber being adapted to receive light emitted from the light source and to emit the light into the illumination region substantially uniformly from the periphery thereof.

It is a further object of the present disclosure to provide a novel system and method for illuminating a panel comprising a light engine providing a source of light, a module having substantially parallel major surfaces and forming an illumination cavity, one surface comprising a light reflective panel, the other major surface comprising a light diffuser and a side-emitting optical fiber positioned about the lateral periphery of said illumination cavity.

It is another object of the present disclosure to provide a novel backlighting module for providing uniformly distributed light to a panel display. The module comprises a planar reflector spaced from and substantially parallel to a planar diffuser which forms the light exit face of the module, and an optical fiber positioned between the reflector and diffuser proximate the lateral periphery thereof, the optical fiber being adapted to emit light substantially uniformly about said lateral periphery.

It is also an object of the present disclosure to provide a novel backlighting module for providing uniformly distributed light to a panel display comprising an illumination cavity having one major boundary formed by a substantially planar reflector and a light exit face formed by a substantially planar diffuser, and an optical fiber positioned within the cavity for transporting light from a light source and into the cavity.

It is still another object of the present disclosure to provide a novel system for illuminating a panel display comprising a light source and a module forming an illumination cavity having a light exit face. The system further comprises an optical fiber adapted to receive light emitted from the light source and emitting the light into the cavity and a light reflective structure in the cavity for directing light emitted by the fiber toward the light exit face.

It is also an object of the present disclosure to provide a novel backlighting module for providing uniformly distributed light to a panel display, the module forming an illumination cavity having one major boundary formed by a reflector and a light exit face formed by a diffuser, and an optical fiber positioned within the cavity for transporting light from a light source and into the cavity.

It is another object of the present disclosure to provide a novel backlighting system for providing uniformly distributed light to a panel display, the system comprising a light transmissive sheet having a reflective coating on one major surface and a light diffusing structure on another major surface forming a light exit face, and an optical fiber coupled to the periphery of the sheet for transporting light from a light source into the sheet.

It is yet another object of the present invention to provide a system and method of backlighting panel displays which filter light at selected wavelengths from the light delivered to the panel.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1 is a cross-sectional view of an embodiment of a backlighting system according to the present disclosure.

FIGS. 2(a)-2(d) are illustrations of embodiments of a backlighting system according to the present disclosure.

FIG. 3(a) is a cross-section of an embodiment of an optical fiber according to the present disclosure.

FIG. 3(b) is a cross-section of another embodiment of an optical fiber according to the present disclosure.

FIGS. 4(a)-4(c) are cross-sectional views of alternative embodiments of a backlighting system according to the present disclosure.

FIGS. 5(a)-5(d) are cross-sectional views of alternative embodiments of a backlighting system according to the present disclosure.

FIG. 6 is an illustration of one embodiment of a light engine according to the present disclosure.

### DETAILED DESCRIPTION OF THE INVENTION

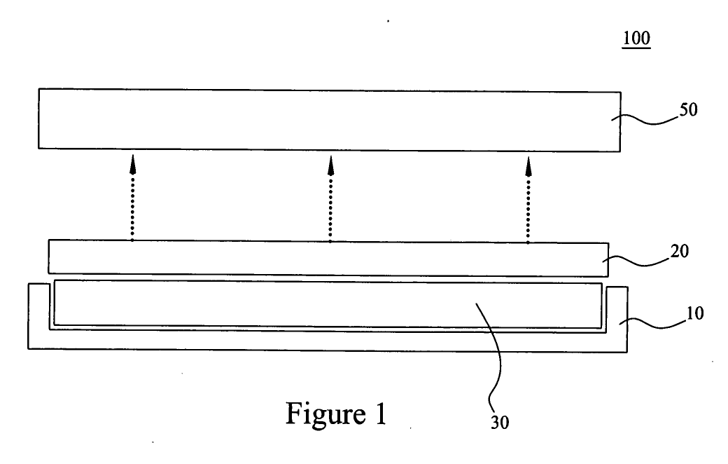

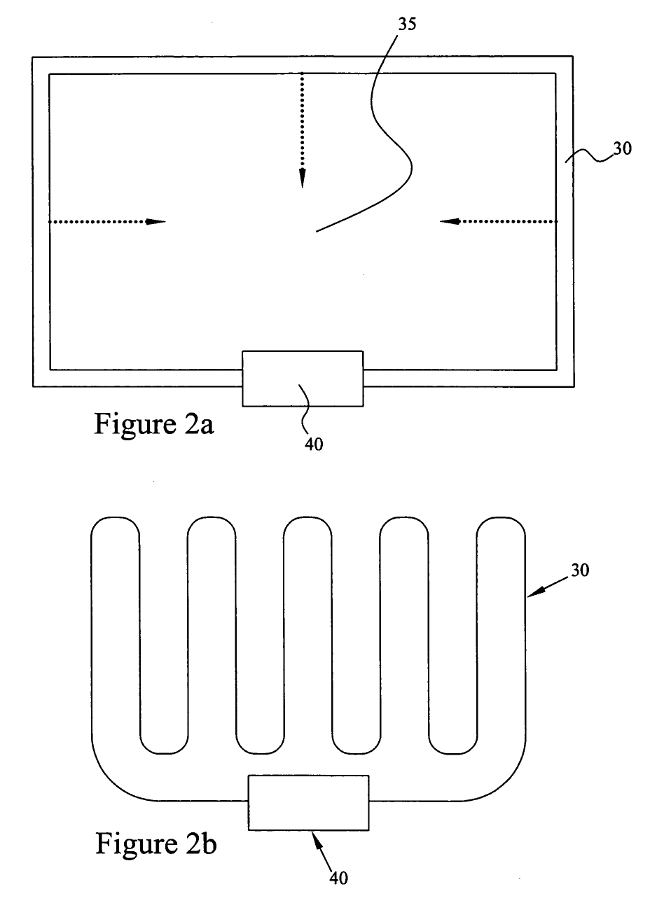

The present disclosure generally finds utility in backlighting systems for panel displays such as LCD display systems FIG. 1 is a cross-sectional view of an embodiment of a backlighting system 100 according to the present disclosure. With reference to FIG. 1, the backlighting system 100 comprises a pair of spaced apart substantially parallel panels 10, 20. One of the panels comprises a reflector 10 having a light reflective surface facing the other panel, a diffuser 20. The diffuser 20 is light transmissive and forms a light exit face of the backlighting system 100. An optical fiber 30 may be positioned between the reflector 10 and the diffuser 20. In this embodiment, the optical fiber 30 forms the lateral periphery of an illumination region 35 (not shown in FIG. 1) and is adapted to receive light from a light engine 40 (not shown in FIG. 1). The optical fiber 30 substantially uniformly emits the light received from the light engine 40 into the illumination region 35 from the periphery thereof as shown in FIG. 2a. The reflector 10 reflects light emitted into the illumination region 35 toward the diffuser 20 which transmits light out of the illumination region 35 for modulation by an LCD panel 50.

The reflector 10 may be uniformly flat or may comprise multiple facets to increase or direct the reflectivity of the light emitted by the optic fiber 30 to thereby minimize dark areas and enhance the brightness of the backlighting system 100. The reflector 10 is preferably placed at the bottom of the backlighting system 100 to reflect the emitted light upwards and the diffuser 20 is placed between the LCD panel 50 and the reflector 10 to homogenize the light. While not shown in FIG. 1, multiple diffusers may be utilized to achieve the desired light output. The diffuser 20 may also be selected according to the spatial distribution of the light so that maximum uniformity can be achieved.

FIGS. 2(a)-2(d) are illustrations of embodiments of a backlighting system according to the present disclosure. With reference to FIGS. 2(a)-2(c), a light engine 40 is shown coupled to an optical fiber 30. The optical fiber 30 may be efficiently coupled at both ends thereof to the light engine 40 by the methods and apparatus disclosed in U.S. patent application Ser. No. 10/949,196 filed Sep. 27, 2004 and entitled, “Integrated Light Distribution System Using Optical Waveguide With No Reflective Coupler,” the content of which is incorporated herein by reference. The light engine 40 may comprise a light source such as an LED, an LED array, a CCFL, a HID lamp, an electrodeless lamp, or other known light sources commonly used in the industry. In the embodiment illustrated by FIG. 2(a), the fiber 30 is positioned to cover an area slightly larger than a corresponding display area. Due to the properties of the fiber 30, light is emitted from the fiber 30 into the illumination area 35 surrounded by the fiber 30. The emitted light is then reflected towards the diffuser 20 (not shown) by the reflector 10 (not shown). Light emissive properties of the backlighting system 100 may also be altered by changing the length of the optical fiber 30.

Alternative embodiments of the backlighting system are illustrated by FIGS. 2(b) and 2(c). With reference to FIGS. 2(b) and 2(c) the optical fiber 30 is operatively connected at both ends thereof to the light engine 40 and positioned to cover an area corresponding to the display area. Due to the positioning and properties of the optical fiber 30, dark areas in a display may be minimized and the brightness and efficiency of the backlighting system 100 augmented. With reference to FIG. 2(d) it is also envisioned that a plurality of optical fibers 31, 32 may be utilized to emit light into an illumination area. Of course, the optical fiber patterns embodied by FIGS. 2(a)-2(d) are illustrative only and should not be construed to limit the scope of the disclosure from the many variations and modifications naturally occurring to those of skill in the art.

The backlighting system may thus utilize a single light source instead of many units of light sources and thus a single ballast may be used instead of the multiple ballasts or inverters used by the CCFL technology. Furthermore, it is envisioned that the light source may be placed outside the backlighting panel thus permitting convenient mounting and replacement of the light source.

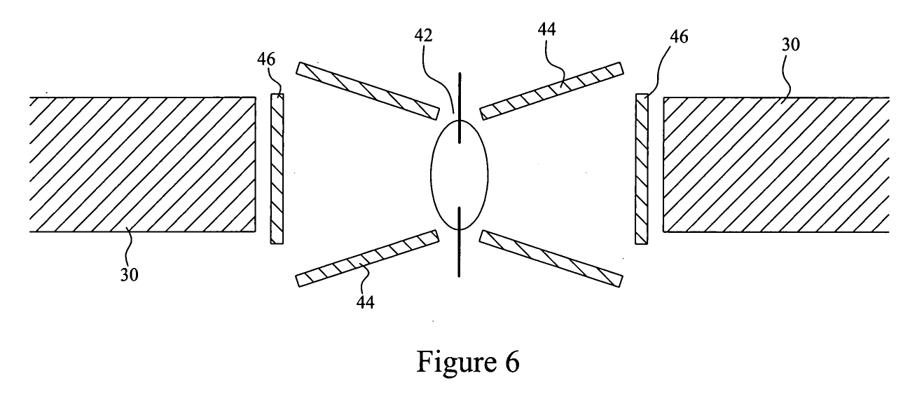

The light source may be heat and UV free through the utilization of filters before the light enters the fiber, thus reducing the light burden upon the panel display and associated materials. With reference to FIG. 6, the light engine may include an HID lamp 42 that emits light in a desired spectrum. The light emitted from the lamp is coupled into the fiber 30 using a reflective coupler 44. The filters 46 may transmit only the desired spectrum into the fiber, thus light in undesirable ranges such as UV and IR may be filtered from the light transported by the fiber 30. Thus the downstream components of the system, e.g. the panel display, are not exposed to the UV or IR.

The light source of an alternative embodiment of the present disclosure may utilize an efficient HID lamp where a 50W or less lamp can produce over 2000 screen lumens. This efficiency is capable of backlighting a large screen LCD panel. In another alternative embodiment, a microwave powered electrodeless lamp may be utilized inside a microwave waveguide. Thus, the dimmable and long-life features of the electrodeless lamp may be utilized in the backlighting system 100. Furthermore, light sources utilized in the backlighting system 100 may be manufactured without mercury so as to create a mercury free and environmentally safe product. Moreover, by using a metal halide light source, the spectral output of the backlighting source may be determined by selecting the components of the lamp fill material. Other light sources, such as LEDs and LED arrays, may also be used for the fiber illumination backlighting.

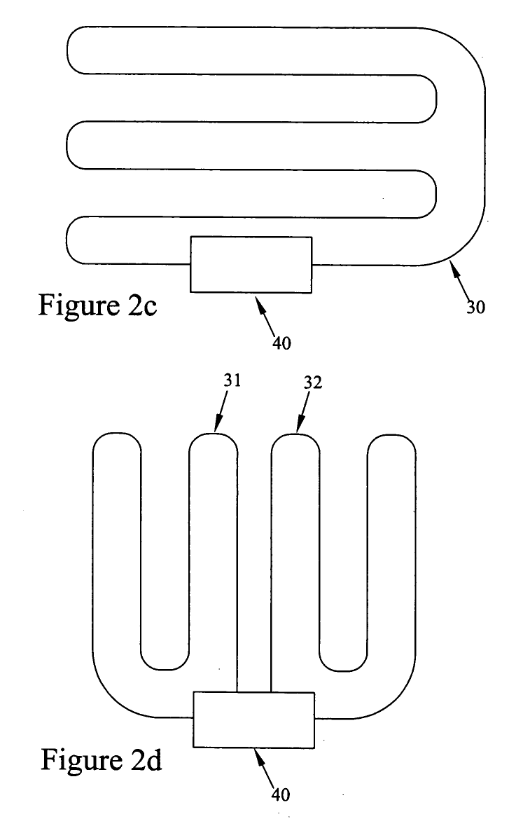

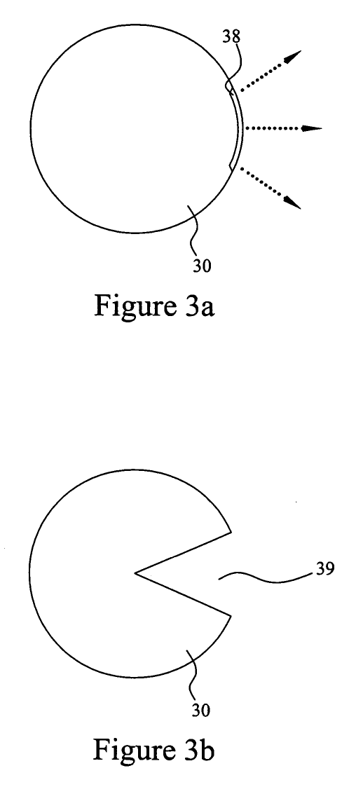

FIG. 3(a) is a cross-section of an embodiment of an optical fiber according to the present disclosure. With reference to FIG. 3(a), emissive properties of the optical fiber 30 may be controlled by coating the fiber with high index refraction materials. A preferred embodiment of the optical fiber 30 is illustrated showing a means of inducing the light confined in the fiber 30 into the illumination area by coating a side of the fiber 30 with a higher refractive index material 38. The high index refraction material 38 changes the internal reflection condition of the fiber 30 so as to induce light out of the fiber. Light is thus emitted out of the fiber 30 due to changed boundary conditions. In this embodiment, a single core fiber is preferable instead of fiber bundles. The side of the fiber 30 having the higher refractive index material 38 may be positioned facing towards the illumination area. It is also envisioned that graded index coatings may be necessary to achieve uniform dispersal of the light.

FIG. 3(b) is a cross-section of another embodiment of an optical fiber according to the present disclosure. With reference to FIG. 3(b), the geometry of the optical fiber 30 may be disrupted to change the internal reflection condition of the fiber 30 so as to induce light out of the fiber and into the illumination area. For example, a notch 39 may be cut into a portion of the fiber 30 to disrupt the geometry thereof. The notch 39 may extend the length of the fiber 30 or a plurality of notches may be cut along the fiber 30 with varying lengths and positions thereon. The specific shape of the notch 39 shown in FIG. 3(b) is illustrative only and should not be construed to limit the scope of the disclosure from the many variations and modifications naturally occurring to those of skill in the art.

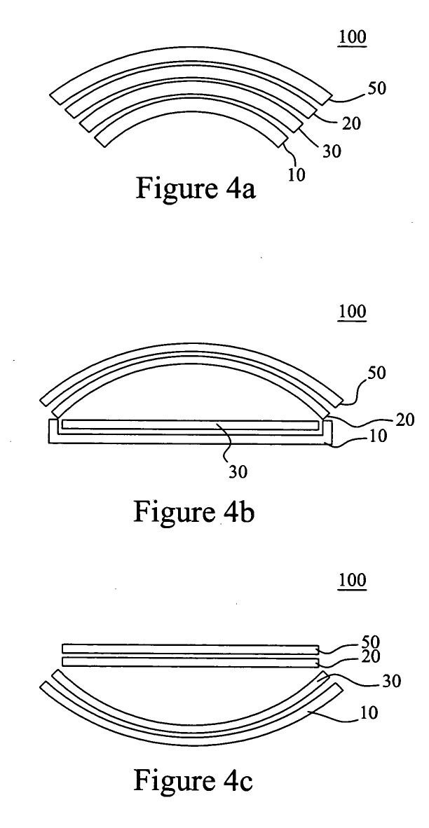

FIGS. 4(a)-4(c) are cross-sectional views of alternative embodiments of a backlighting system 100 according to the present disclosure. With reference to FIGS. 4(a)-4(c), the geometries and shapes of the LCD panel 50, the diffuser 20, the optical fiber 30 and the reflector 10 may be changed with regard to the other components depending upon the requirements of the system. For example, FIG. 4(a) illustrates a concave geometry for the panel 50, diffuser 20, fiber 30 and reflector 10. As illustrated by FIG. 4(b), the reflector 10 and fiber 30 may be substantially planar and the panel 50 and diffuser 20 may be concave. Further, as illustrated by FIG. 4(c), the reflector 10 and fiber 30 may be convex; whereas, the panel 50 and diffuser 20 may be substantially planar. Of course, the geometries shown by FIGS. 4(a)-4(c) are illustrative only and should not be construed to limit the scope of the disclosure from the many variations and modifications naturally occurring to those of skill in the art.

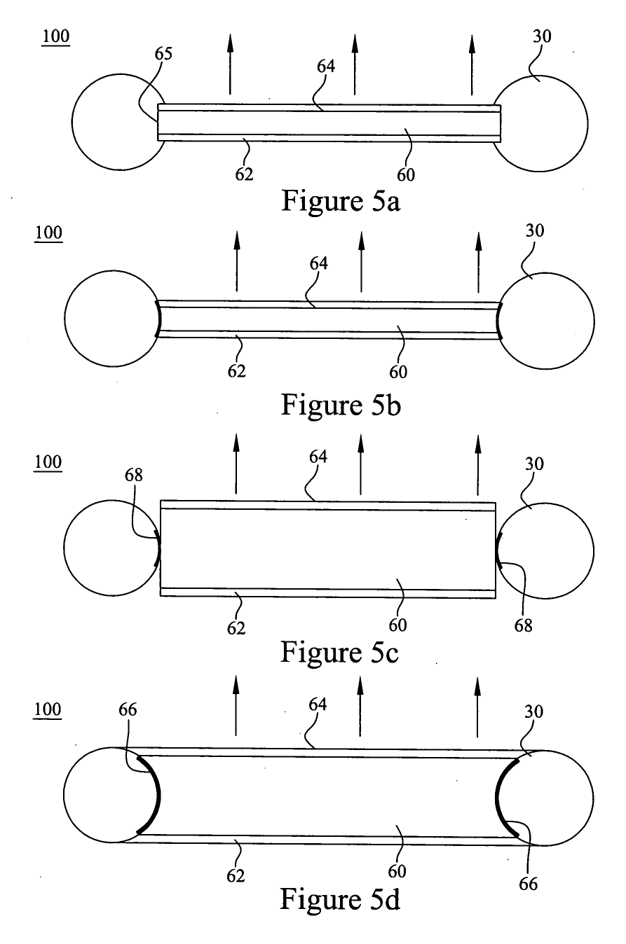

FIGS. 5(a)-5(d) are cross-sectional views of alternative embodiments of a backlighting system 100 according to the present disclosure. With reference to FIGS. 5(a)-5(d), the backlighting system 100 comprises a light transmissive sheet 60 having a reflector 62 (such as a reflective coating) on one major surface of the sheet 60, and a light diffusing structure 64 (such as a flat diffuser) on the other major surface of the sheet 60. The diffusing structure 64 forms a light exit face of the backlighting system 100.

A side-emitting optical fiber 30 may be positioned on the lateral edges of the sheet 60 for transporting light from a light source (not shown) into the sheet 60. In the embodiment illustrated by FIG. 5(a), the sheet 60 may be coupled to the optical fiber 30 by a notch 65 formed in the optical fiber 30. While coupling the sheet 60 to the optical fiber 30, the notch 65 also disrupts the geometry of the optical fiber 30 to thereby change the internal reflection condition of the fiber 30 so as to induce light to “leak” out of the fiber and into the sheet 60. The sheet may be formed from any suitable flexible or rigid light transmissive material. The specific shape of the notch 65 shown in FIG. 5(a) is illustrative only and should not be construed to limit the scope of the disclosure from the many variations and modifications naturally occurring to those of skill in the art.

The optical fiber 30 substantially uniformly emits the light received from a light engine (not shown) into the sheet 60 from the periphery thereof as shown in FIGS. 5(a)-5(d). The reflector 62 reflects light emitted into the sheet 60 toward the diffusing structure 64 which transmits light out of the sheet 60 for modulation by a panel display (not shown), e.g., an LCD panel. The reflector 62 may be uniformly flat, may be a coating of material on one side of the sheet 60, or may further comprise multiple facets to increase or direct the reflectivity of the light emitted by the optical fiber 30 to thereby obtain the desired light distribution at the light exit face.

With reference to FIGS. 5(b) -5(d), the light transmissive sheet 60 may be attached to the optical fiber 30 by a transparent or light transmissive glue 66. In another embodiment, the glue 66 may possess a high index of refraction to thereby control the emissive properties of the optical fiber and thus induce the light confined in the fiber 30 into the sheet 60. Of course, the glue 66 may be fully transparent and the emissive properties of the optical fiber 30 may be controlled by coating the optical fiber 30 with high index refraction materials 68.

Accordingly, the high index refraction material 68 changes the internal reflection condition of the optical fiber 30 so as to induce light out of the fiber. Light is thus emitted out of the optical fiber 30 due to changed boundary conditions. It is also envisioned that graded index coatings may be utilized to achieve uniform dispersal of the light exiting the fiber core.

As illustrated by FIGS. 5(a)-5(d), the cross-sectional geometries of the sheet 60, reflector 62, diffusing structure 64, and optical fiber 30 may be changed with regard to the requirements of the backlighting system 100. The embodiments illustrated in FIGS. 5(a)-5(d) may be utilized as a module in a backlighting system, and a plurality of these modules may be employed to increase the brightness and efficacy of a backlighting system or may be employed in displays having non-traditional dimensions. For example, the alternative embodiments illustrated by FIGS. 5(a)-5(d) may be utilized to provide backlighting for displays having geometries ranging from the traditional rectangular and square geometries to circular, oval, diamond and rhombic or the like geometries. Such a diversity of display geometries may find application in industries such as advertising, automotive, and aerospace as well as the afore-mentioned industries of television, radiology, commercial signage, computers, multi-media, cell phones, PDAs, and other electronic industries. Of course, the geometries shown by FIGS. 5(a)-5(d) and discussed above are illustrative only and should not be construed to limit the scope of the disclosure from the many variations and modifications naturally occurring to those of skill in the art.

While preferred embodiments of the present invention have been described, it is to be understood that the embodiments described are illustrative only and the scope of the invention is to be defined solely by the appended claims when accorded a full range of equivalence, many variations and modifications naturally occurring to those of skill in the art from a perusal hereof.

What is claimed is:

1. A backlighting device comprising:
a light source;
a pair of spaced apart substantially parallel panels, one of said panels having a light reflective surface facing the other panel, the other of said panels being light transmissive and forming a light exit face of said device;
an optical fiber positioned between said panels and forming the lateral periphery of an illumination region, said fiber being adapted to receive light emitted from said source and to emit the light into said illumination region substantially uniformly from the periphery thereof,
whereby the reflective panel reflects light emitted into the illumination region toward the transmissive panel which transmits light out of said region.

2. The backlighting device of claim 1 wherein said light source is a high intensity discharge lamp.

3. The backlighting device of claim 2 wherein said light source is a metal halide lamp.

4. The backlighting device of claim 1 wherein said light source is an electrodeless lamp.

5. The backlighting device of claim 1 wherein said light source is an LED array.

6. The backlighting device of claim 1 wherein said light source is a cold cathode fluorescent lamp

7. The backlighting device of claim 1 wherein said light source is external to the illumination region.

8. The backlighting device of claim 1 wherein the optical fiber is a side-emitting optical fiber.

9. The backlighting device of claim 1 wherein said reflective panel further comprises a plurality of reflective facets.

10. The backlighting device of claim 1 wherein the light source is directly coupled to the optical fiber.

11. The backlighting device of claim 10 wherein the light source is contained within the optical fiber.

12. A system for illuminating a panel comprising;
a light engine providing a source of light;
a module having substantially parallel major surfaces and forming an illumination cavity, one surface comprising a light reflective panel, the other major surface comprising a light diffuser; and
a side-emitting optical fiber positioned about the lateral periphery of said illumination cavity, said optical fiber being adapted to receive light emitted from said light source and to emit the light substantially uniformly into said illumination cavity from the periphery thereof,
whereby said reflective panel reflects light emitted into said cavity toward said diffuser which forms a light exit face of said module.

13. The system of claim 12 wherein said light engine is external to said module.

14. The system of claim 12 wherein said reflective panel further comprises a plurality of reflective facets.

15. The system of claim 12 wherein said light engine comprises a light source and a reflective coupler for coupling light emitted from said source into said fiber.

16. The system of claim 15 wherein said light engine further comprises a filter for filtering light emitted from said light source in the UV range prior to entering said fiber.

17. The system of claim 12 wherein said light engine comprises a light source internal of said fiber.

18. A back lighting module for providing uniformly distributed light to a panel display, said module forming an illumination cavity having one major boundary formed by a substantially planar reflector and a light exit face formed by a substantially planar diffuser, and an optical fiber positioned within said cavity for transporting light from a light source and into said cavity.

19. The back lighting module of claim 18 wherein said optical fiber is positioned proximate the lateral periphery of said cavity and is adapted to emit light into said cavity substantially uniformly from said lateral periphery.

20. A system for illuminating a panel display comprising:
a light source;
a module forming an illumination cavity having a light exit face;
an optical fiber adapted to receive light emitted from said light source and emitting the light into said cavity; and
a light reflective structure in said cavity for directing light emitted by said fiber toward said light exit face.

21. A back lighting module for providing uniformly distributed light to a panel display, said module forming an illumination region having one major boundary that is light reflective and another major boundary having a light diffusing structure and forming a light exit face a light exit face, and an optical fiber for transporting light from a light source and into said region.

22. The backlighting module of claim 21 wherein at least one of said major boundaries is substantially planar.

23. The backlighting module of claim 21 wherein at least one of said major boundaries is curved.

24. A back lighting system for providing uniformly distributed light to a panel display, said system comprising a light transmissive body having one major boundary that is light reflective and another major boundary having a light diffusing structure forming a light exit face, and an optical fiber coupled to the periphery of said body for transporting light from a light source and into said body.

25. The backlighting system of claim 24 wherein the optical fiber is coupled to the sheet by positioning the lateral edge of the sheet in a notch formed along the fiber.

26. The backlighting system of claim 24 wherein the optical fiber is coupled to the sheet by a light transmissive glue.

27. The backlighting system of claim 26 wherein said glue has a high index of refraction relative to the index of refraction of the fiber core.

28. A backlighting system for a panel display comprising a light source, a light diffusing structure for transmitting a substantially uniformly distributed light over a predetermined area, and a light guide for guiding the light emitted from said light source to said diffusing structure, the improvement wherein said light guide comprises optical fiber.

29. The backlighting system of claim 28 further comprising a filter for filtering light at selected wavelengths from the light guided to said diffusing structure.

30. The backlighting system of claim 29 wherein said filter filters light in the UV range of wavelengths.
